(19) United States
(12) Patent Application Publication
(10) Pub. No.: US 2025/0081995 A1
(43) Pub. Date: Mar. 13, 2025

(54) IMITATION SALMON LOX PRODUCT AND METHOD OF MANUFACTURE

(71) Applicant: Nicole Derseweh, Los Angeles, CA (US)

(72) Inventor: Nicole Derseweh, Los Angeles, CA (US)

(21) Appl. No.: 18/244,065

(22) Filed: Sep. 8, 2023

(51) Int. Cl. A23L 19/00; A23L 17/60; A23L 27/12; A23L 27/14

(52) U.S. Cl. CPC A23L 19/05; A23L 17/60; A23L 27/13; A23L 27/14

(57) ABSTRACT

An imitation salmon lox product and its method of manufacture. The product includes carrots that are wrapped in nori sheets and salt cured to extract water from the cells of the carrots. The salt cured carrots are then smoked, sliced, marinaded, vacuum sealed, and refrigerated. The result is an imitation salmon lox product with the taste and consistency of traditional salmon lox.

### COPYRIGHT STATEMENT

This patent document contains material subject to copyright protection. The copyright owner has no objection to the reproduction of this patent document or any related materials in the files of the United States Patent and Trademark Office, but otherwise reserves all copyrights whatsoever.

### FIELD OF THE INVENTION

This invention relates to food products, including an imitation salmon lox product and its method of manufacture.

### BACKGROUND

Salmon lox are consumed and enjoyed throughout the world.

However, some people who may wish to enjoy the consumption of salmon lox may not be able to do so because of their dietary restrictions. For example, people who are vegan may not be able to consume salmon lox because the salmon lox include fish meat.

Accordingly, there is a need for an imitation salmon lox product and its method of manufacture.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 shows aspects of an imitation salmon lox product according to exemplary embodiments hereof; and

FIGS. 2-7 show flowcharts depicting actions taken to manufacture an imitation salmon lox product product according to exemplary embodiments hereof.

### DETAILED DESCRIPTION OF EXEMPLARY EMBODIMENTS

In general, the presently disclosed system and method provides an imitation salmon lox product and its method of manufacture. As described herein, the product includes a unique and novel combination of ingredients prepared using a unique and novel method. The result is a delicious imitation salmon lox product that tastes and has the consistency of traditional salmon lox.

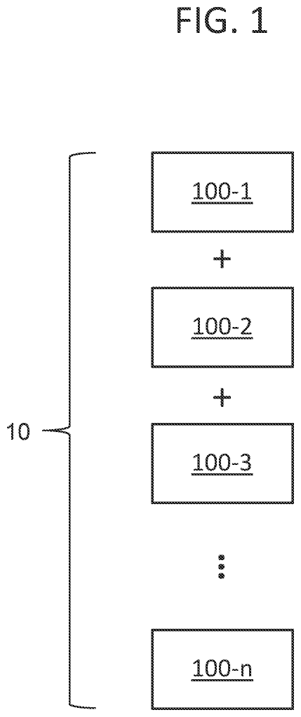

In some embodiments, as shown in FIG. 1, the imitation salmon lox product 10 includes a plurality of elements that may be combined and/or used to make the product 10 using one or more particular methods as described herein. For example, in some embodiments the product 10 may include the elements 100-1, 100-2, 100-3, . . . 100-n (individually and collectively 100).

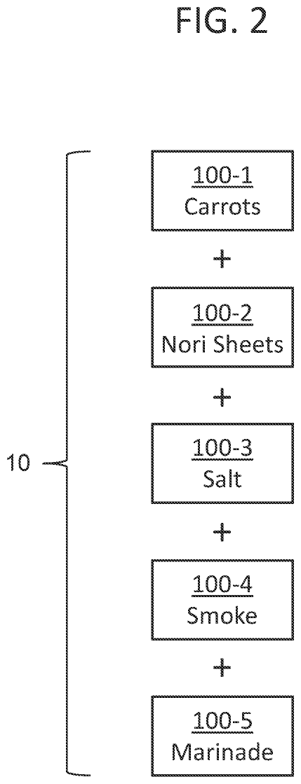

In some embodiments, as shown in FIG. 2, the following elements 100 are used to create the imitation salmon lox product 10:

100-1: Raw carrots;

100-2: Nori sheets;

100-3: Salt;

100-4: Aromatic smoke (e.g., from smoker device); and

100-5: Marinade comprising Old Bay Seasoning®, paprika, nori flakes, dill, lemon juice, apple cider vinegar, and olive oil.

It is understood that the elements 100 described above are not limiting and that the product 10 may include additional elements 100 and/or may not necessarily include all of the elements 100.

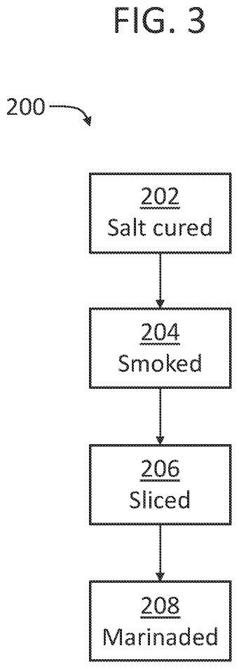

In some embodiments, as shown in FIG. 3, the imitation salmon lox product 10 is manufactured by performing the following actions 200.

At 202, the raw carrots 100-1 are salt cured. This also may include wrapping the carrots in nori sheets prior to the salt curing process;

At 204, the outcome of 202 is treated with aromatic smoke;

At 206, the outcome of 204 is prepared (e.g., sliced); and

At 208, the outcome of 206 is marinaded.

In some embodiments, the purpose of action 202 is to salt cure the carrots in order to specifically extract water from the cells of the carrot. This is to transform the carrots from having typical dense carrot consistency to having a flaky texture that resembles the texture of salmon. This is in contrast to the normal use of a salt curing process which is to preserve the food that is being salt cured.

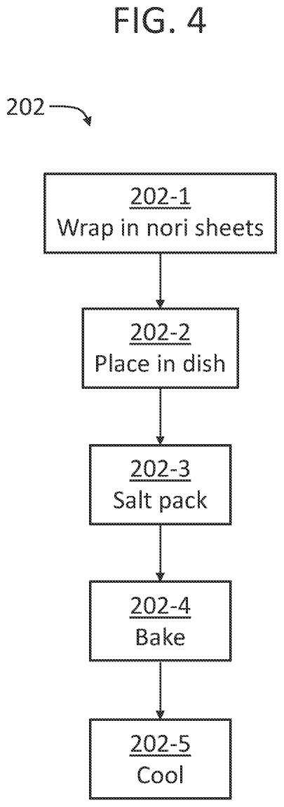

In some embodiments, as shown in FIG. 4, the actions 202 further comprise:

202-1: Wrap large raw carrots in one or more nori sheets. As is known, nori sheets typically comprise thin sheets of edible dried seaweed.

202-2: Place wrapped carrots in large baking dish;

202-3: Pack wrapped carrots in salt (e.g., cover the wrapped carrots in at least a layer of salt, and preferably, completely burying the wrapped carrots in salt so that no part of the wrapped carrots are exposed);

202-4: Cover baking dish and bake at 300° F.-450° F (and preferably at 400° F.) for 30-120 minutes (and preferably for 60-90 minutes) depending on the size of the carrots.

202-5: Remove from heat, allow to cool, and rub off excess salt and nori material.

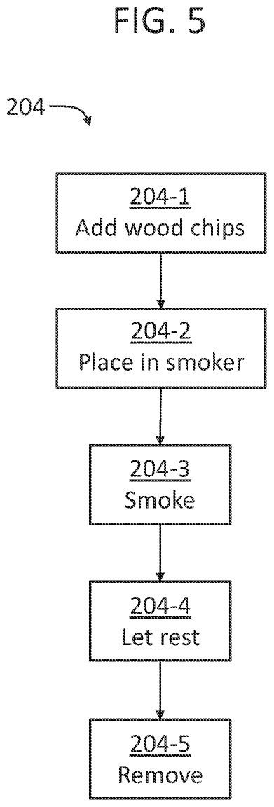

In some embodiments, as shown in FIG. 5, the actions 204 further comprise:

204-1: Place wood chips of desired type into a smoking device and ignite device;

204-2: Place the results of 202 into the smoking device;

204-3: Smoke the carrots for approximately 15 minutes;

204-4: Turn off smoking device and allow carrots to rest in the smoking device (i.e., in the smoke remaining within the smoking device) for approximately 5 minutes; and

204-5: Remove carrots from the smoking device.

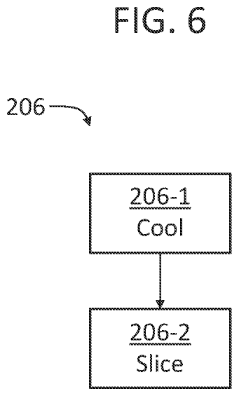

In some embodiments, as shown in FIG. 6, the actions 206 further comprise:

206-1: Allow the smoked carrots from 204 to cool until they may be handled; and

206-2: Using a mandolin or deli meat slicer (or similar), shave the carrots into thin lox-like pieces (e.g., into slices approximately 1 mm-5 mm thick).

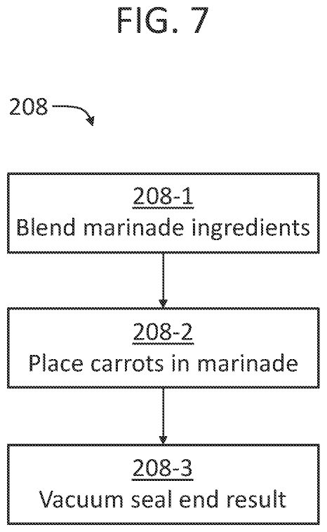

In some embodiments, as shown in FIG. 7, the actions 208 further comprise:

208-1: Whisk together in a bowl the following: Old Bay Seasoning®, paprika, nori flakes, dill, lemon juice (or apple cider vinegar), and olive oil;

208-2: Immerse the sliced carrots from 204 with the results (the marinade) from 208-1, cover, and let sit for about one hour; and

208-3: Vacuum seal the marinaded carrots from 208-2 and refrigerate during storage.

It is understood that not all of the actions 200, 202, 204, 206, and 206 described above may necessarily be performed, that additional actions may be performed, and that the actions 200, 202, 204, 206, and 206 may be performed in different order(s).

It is understood that any aspects or elements of any embodiment described herein or otherwise may be combined with any other aspect or element of any other embodiment to form one or more additional embodiments all of which are within the scope of the product 10 and its method of manufacture.

Those of ordinary skill in the art will appreciate and understand, upon reading this description, that embodiments hereof may provide different and/or other advantages, and that not all embodiments or implementations need have all advantages.

Where a process is described herein, those of ordinary skill in the art will appreciate that the process may operate without any user intervention. In another embodiment, the process includes some human intervention (e.g., a step is performed by or with the assistance of a human).

As used herein, including in the claims, the phrase “at least some” means “one or more,” and includes the case of only one. Thus, e.g., the phrase “at least some ABCs” means “one or more ABCs”, and includes the case of only one ABC.

As used herein, including in the claims, term “at least one” should be understood as meaning “one or more”, and therefore includes both embodiments that include one or multiple components. Furthermore, dependent claims that refer to independent claims that describe features with “at least one” have the same meaning, both when the feature is referred to as “the” and “the at least one”.

As used in this description, the term “portion” means some or all. So, for example, “A portion of X” may include some of “X” or all of “X”. In the context of a conversation, the term “portion” means some or all of the conversation.

As used herein, including in the claims, the phrase “using” means “using at least,” and is not exclusive. Thus, e.g., the phrase “using X” means “using at least X.” Unless specifically stated by use of the word “only”, the phrase “using X” does not mean “using only X.”

As used herein, including in the claims, the phrase “based on” means “based in part on” or “based, at least in part, on,” and is not exclusive. Thus, e.g., the phrase “based on factor X” means “based in part on factor X” or “based, at least in part, on factor X.” Unless specifically stated by use of the word “only”, the phrase “based on X” does not mean “based only on X.”

In general, as used herein, including in the claims, unless the word “only” is specifically used in a phrase, it should not be read into that phrase.

As used herein, including in the claims, the phrase “distinct” means “at least partially distinct.” Unless specifically stated, distinct does not mean fully distinct. Thus, e.g., the phrase, “X is distinct from Y” means that “X is at least partially distinct from Y,” and does not mean that “X is fully distinct from Y.” Thus, as used herein, including in the claims, the phrase “X is distinct from Y” means that X differs from Y in at least some way.

It should be appreciated that the words “first,” “second,” and so on, in the description and claims, are used to distinguish or identify, and not to show a serial or numerical limitation. Similarly, letter labels (e.g., “(A)”, “(B)”, “(C)”, and so on, or “(a)”, “(b)”, and so on) and/or numbers (e.g., “(i)”, “(ii)”, and so on) are used to assist in readability and to help distinguish and/or identify, and are not intended to be otherwise limiting or to impose or imply any serial or numerical limitations or orderings. Similarly, words such as “particular,” “specific,” “certain,” and “given,” in the description and claims, if used, are to distinguish or identify, and are not intended to be otherwise limiting.

As used herein, including in the claims, the terms “multiple” and “plurality” mean “two or more,” and include the case of “two.” Thus, e.g., the phrase “multiple ABCs,” means “two or more ABCs,” and includes “two ABCs.” Similarly, e.g., the phrase “multiple PQRs,” means “two or more PQRs,” and includes “two PQRs.”

The present invention also covers the exact terms, features, values and ranges, etc. in case these terms, features, values and ranges etc. are used in conjunction with terms such as about, around, generally, substantially, essentially, at least etc. (i.e., “about 3” or “approximately 3” shall also cover exactly 3 or “substantially constant” shall also cover exactly constant).

As used herein, including in the claims, singular forms of terms are to be construed as also including the plural form and vice versa, unless the context indicates otherwise. Thus, it should be noted that as used herein, the singular forms “a,” “an,” and “the” include plural references unless the context clearly dictates otherwise.

Throughout the description and claims, the terms “comprise”, “including”, “having”, and “contain” and their variations should be understood as meaning “including but not limited to”, and are not intended to exclude other components unless specifically so stated.

It will be appreciated that variations to the embodiments of the invention can be made while still falling within the scope of the invention. Alternative features serving the same, equivalent or similar purpose can replace features disclosed in the specification, unless stated otherwise. Thus, unless stated otherwise, each feature disclosed represents one example of a generic series of equivalent or similar features.

The present invention also covers the exact terms, features, values and ranges, etc. in case these terms, features, values and ranges etc. are used in conjunction with terms such as about, around, generally, substantially, essentially, at least etc. (i.e., “about 3” shall also cover exactly 3 or “substantially constant” shall also cover exactly constant).

Use of exemplary language, such as “for instance”, “such as”, “for example” (“e.g.,”) and the like, is merely intended to better illustrate the invention and does not indicate a limitation on the scope of the invention unless specifically so claimed.

While the invention has been described in connection with what is presently considered to be the most practical and preferred embodiments, it is to be understood that the invention is not to be limited to the disclosed embodiment, but on the contrary, is intended to cover various modifications and equivalent arrangements included within the spirit and scope of the appended claims.

1. A method of making an imitation salmon lox product, the method comprising:
(A) providing at least one raw carrot;
(B) wrapping the at least one raw carrot in a nori sheet;
(C) salt curing the result of (B);
(D) treating the result of (C) with heated aromatic smoke using an ignited smoker device;
(E) preparing a marinade; and
(F) treating the result of (D) with the marinade of (E);
wherein the treating of the result of (C) with aromatic smoke using an ignited smoker device in (D) is performed prior to the treating the result of (D) with the marinade of (E) to further reduce a moister content of the at least one raw carrot prior to the marination step of (F).

2. The method of claim 1 wherein the salt curing in (C) further comprises:
(C)(1) packing the result of (B) in salt; and
(C)(2) baking the results of (C)(1) at a first temperature for a first amount of time.

3. The method of claim 2 wherein the first temperature is 300° F. to 450° F. and the first amount of time is 30 minutes to 120 minutes.

4. The method of claim 1 wherein the preparing the marinade in (E) further comprises:
(E)(1) blending together paprika, nori flakes, dill, lemon juice, and olive oil.

5. The method of claim 1 further comprising:
(D)(1) slicing the result of (D).

6. The method of claim 1 wherein treating the result of (D) with the result of (E) in (F) further comprises:
(F)(1) allowing the result of (D) to sit immersed in the result of (E) for at least 15 minutes.

7. A method of making an imitation salmon lox product, the method comprising:
(A) providing at least one raw carrot;
(B) wrapping the at least one raw carrot in a nori sheet;
(C) salt curing the result of (B) by packing the result of (B) in salt and baking it at 400° F. for 60-90 minutes;
(D) treating the result of (C) with heated aromatic smoke using an ignited smoker device;
(E) slicing the result of (D) into slices about 1 mm-5 mm thick;
(F) preparing a marinade by blending together paprika, nori flakes, dill, lemon juice, and olive oil; and
(F) marinading the result of (D) with the result of (E) for at least one hour;
wherein the treating of the result of (C) with heated aromatic smoke using an ignited smoker device in (D) is performed prior to the treating the result of (D) with the marinade of (E) to further reduce a moister content of the at least one raw carrot prior to the marination step of (F).
